(19) United States
(12) Patent Application Publication
(10) Pub. No.: US 2024/0206396 A1
(43) Pub. Date: Jun. 27, 2024

(54) SYSTEM AND METHOD FOR DETECTING FOREIGN OBJECTS WITHIN AN AGRICULTURAL HARVESTER

(71) Applicant: CNH Industrial Brasil Ltda., Nova Lima (BR)

(72) Inventor: João Augusto Marcolin Lucca, Piracicaba (BR)

(21) Appl. No.: 18/555,690

(22) PCT Filed: Apr. 13, 2022
(86) PCT No.: PCT/BR2022/050132

§ 371 Date: Oct. 16, 2023

(30) Foreign Application Priority Data
Apr. 16, 2021 (BR) 102021007264-4

(51) Int. Cl. A01D 57/22; A01D 45/10; A01D 69/03; G01P 13/00; G01V 3/08

(52) U.S. Cl. CPC A01D 57/22; A01D 45/10; G01P 13/00; G01V 3/08; A01D 69/03

(57) ABSTRACT

A system for detecting foreign objects within an agricultural harvester may include a feed roller assembly configured to receive and direct the flow of harvested materials along a flow path defined between a plurality of bottom rollers and a plurality of top rollers from a first end of the feed roller assembly to a second end of the feed roller assembly. The system may further include a first movement sensor configured to generate displacement data indicative of displacement of a first roller of the plurality of top rollers, a second movement sensor configured to generate displacement data indicative of displacement of a second roller of the plurality of top rollers, and a controller configured to determine when a foreign object is present within the flow of harvested materials based at least in part on the displacement data received from the first and second movement sensors.

### FIELD OF THE INVENTION

The present disclosure relates generally to agricultural harvesters, such as sugarcane harvesters, and, more particularly, to systems and methods for detecting foreign objects within a feed roller assembly of an agricultural harvester.

### BACKGROUND OF THE INVENTION

Typically, agricultural harvesters include an assembly of processing equipment for processing harvested crop materials. For instance, within a sugarcane harvester, severed sugarcane stalks are conveyed via a feed roller assembly to a chopper assembly that cuts or chops the sugarcane stalks into pieces or billets (e.g., 6 inch cane sections). The processed crop material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

During operation of the harvester, objects such as rocks or broken-off pieces of metal in the field may be fed into the feed roller assembly along with the severed sugarcane stalks. These foreign objects may cause damage to blades of the chopper assembly, which reduces the efficiency of the chopper assembly. However, with existing harvesters, an operator is not able to identify when foreign objects have been picked up with the sugarcane stalks and, thus, is not able to stop the feed roller assembly in time to prevent the blades from being damaged.

Accordingly, a system and method for detecting foreign objects within a feed roller assembly of an agricultural harvester would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for detecting foreign objects within an agricultural harvester. The system includes a feed roller assembly extending between a first end and a second end and including a plurality of bottom rollers and a plurality of top rollers. The feed roller assembly is configured to receive a flow of harvested materials and direct the flow of harvested materials along a flow path defined between the plurality of bottom rollers and the plurality of top rollers from the first end of the feed roller assembly to the second end of the feed roller assembly. The system further includes a first movement sensor configured to generate displacement data indicative of displacement of a first roller of the plurality of top rollers, and a second movement sensor configured to generate displacement data indicative of displacement of a second roller of the plurality of top rollers. Additionally, the system includes a controller communicatively coupled to the first and second movement sensors. The controller is configured to determine when a foreign object is present within the flow of harvested materials based at least in part on the displacement data received from the first and second movement sensors.

In another aspect, the present subject matter is directed to a sugarcane harvester. The sugarcane harvester includes a base cutter assembly configured to sever sugarcane stalks, and a feed roller assembly extending between a first end and a second end and having a plurality of bottom rollers and a plurality of top rollers. The feed roller assembly is configured to receive a flow of the sugarcane stalks from the base cutter assembly and direct the flow of the sugarcane stalks along a flow path defined between the plurality of bottom rollers and the plurality of top rollers from the first end of the feed roller assembly to the second end of the feed roller assembly. The sugarcane harvester further includes a chopper assembly configured to receive the flow of the sugarcane stalks from the feed roller assembly and chop the flow of the sugarcane stalks into billets. Moreover, the sugarcane harvester includes a first movement sensor configured to generate displacement data indicative of displacement of a first roller of the plurality of top rollers, and a second movement sensor configured to generate displacement data indicative of displacement of a second roller of the plurality of top rollers. Additionally, the sugarcane harvester includes a controller communicatively coupled to the first and second movement sensors, with the controller being configured to determine when a foreign object is present within the flow of the sugarcane stalks based at least in part on the displacement data received from the first and second movement sensors and to control an operation of the agricultural harvester when the foreign object is present in the flow of the sugarcane stalks to protect the chopper assembly.

In a further aspect, the present subject matter is directed to a method for detecting foreign objects for an agricultural harvester, where the agricultural harvester has a feed roller assembly extending between a first end and a second end, the feed roller assembly including a plurality of bottom rollers and a plurality of top rollers. The feed roller assembly is configured to receive a flow of harvested materials and direct the flow of harvested materials along a flow path defined between the plurality of bottom rollers and the plurality of top rollers from the first end of the feed roller assembly to the second end of the feed roller assembly. The method includes receiving, with one or more computing devices, displacement data indicative of displacement of a first roller of the plurality of top rollers and displacement of a second roller of the plurality of top rollers. The method further includes determining, with the one or more computing devices, that a foreign object is present within the flow of harvested materials based at least in part on the displacement data. Additionally, the method includes controlling, with the one or more computing devices, an operation of at least one of the feed roller assembly or a user interface in response to determining that the foreign object is present within the flow of harvested materials.

In an additional aspect, the present subject matter is directed to a system for detecting foreign objects within an agricultural harvester. The system includes a feed roller assembly extending between a first end and a second end and including a plurality of bottom rollers and a plurality of top rollers. The feed roller assembly is configured to receive a flow of harvested materials and direct the flow of harvested materials along a flow path defined between the plurality of bottom rollers and the plurality of top rollers from the first end of the feed roller assembly to the second end of the feed roller assembly. The system further includes a metal detecting sensor associated with at least one of the plurality of bottom rollers or the plurality of top rollers, where the metal detecting sensor is configured to generate data indicative of a metallic property of the flow of harvested materials. Additionally, the system includes a controller communicatively coupled to the metal detecting sensor. The controller is configured to determine that a metallic object is present in the flow of harvested materials based at least in part on the metallic property of the flow of harvested material exceeding a metallic property threshold.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a side view of a portion of an agricultural harvester in accordance with aspects of the present subject matter, particularly illustrating one embodiment of a feed roller assembly of the agricultural harvester;

FIGS. 3A and 3B illustrate a detail view of a top roller of a feed roller assembly of an agricultural harvester in accordance with aspects of the present subject matter, particularly illustrating the top roller in a lowered position and in a raised position;

FIG. 4 illustrates a schematic view of a system for detecting foreign objects within a feed roller assembly of an agricultural harvester in accordance with aspects of the present subject matter;

FIGS. 5A and 5B illustrate example embodiments of displacement maps generated from data collected by movements sensors of a sensor assembly for detecting foreign objects within a feed roller assembly of an agricultural harvester in accordance with aspects of the present subject matter, particularly illustrating a displacement map of a first roller and a displacement map of a second roller, respectively; and

FIG. 6 illustrates a flow diagram of one embodiment of a method for detecting foreign objects within a feed roller assembly of an agricultural harvester in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for detecting foreign objects within a feed roller assembly of an agricultural harvester, such as a sugarcane harvester. Specifically, in several embodiments, the disclosed system and method may be used to determine when a foreign object is present within the feed roller assembly to prevent damage to a chopper assembly positioned downstream of the feed roller assembly. For instance, the feed roller assembly may extend between a first end and a second end and include a plurality of top and bottom rollers. The feed roller assembly receives a flow of harvested materials (e.g., severed sugarcane stalks) from a base cutter assembly and directs the flow of harvested materials along a flow path defined between the top and bottom rollers from the first end to the second end of the feed roller assembly. The top rollers may be movable to adjust the distance between the top and the bottom rollers to allow for different thicknesses of the flow of harvested materials.

In accordance with aspects of the present subject matter, the displacement of at least two of the top rollers away from the respective bottom rollers may be monitored using data from movement sensors provided in association with the feed roller assembly to determine when a foreign object (e.g., a rock) is present within the flow of harvested materials. For instance, when a larger than normal displacement occurs at a first of the at least two top rollers and then again at a second of the at least two top rollers, downstream of the first top roller within a certain time interval, the controller may determine that a foreign object is present within the flow of harvested materials. Similarly, if the displacement occurs at a faster rate than expected at a first of the at least two top rollers and then at a second of the at least two top rollers downstream of the first top roller within a certain time interval, the controller may determine that a foreign object is present within the flow of harvested materials.

Additionally, in some embodiments, a metal detecting sensor may be provided in association with the feed roller assembly that generates data indicative of a metallic property of the flow of harvested materials. A controller of the disclosed system may monitor the metallic property of the flow of harvested materials based on the data received from the metal detecting sensor and determine if a metallic foreign object is present within the flow of harvested materials. For instance, the controller may determine that a metallic foreign object is present within the flow of harvested materials if the metallic property of the flow of harvested materials exceeds a metallic property threshold.

If a foreign object (e.g., rock or metal) is detected, the controller of the disclosed system may be configured to stop the feed roller assembly, stop the chopper assembly, and/or indicate to an operator via a user interface that the foreign object is present. The operator may then remove the foreign object and thus, prevent blades of the chopper assembly directly downstream of the feed roller assembly from becoming damaged.

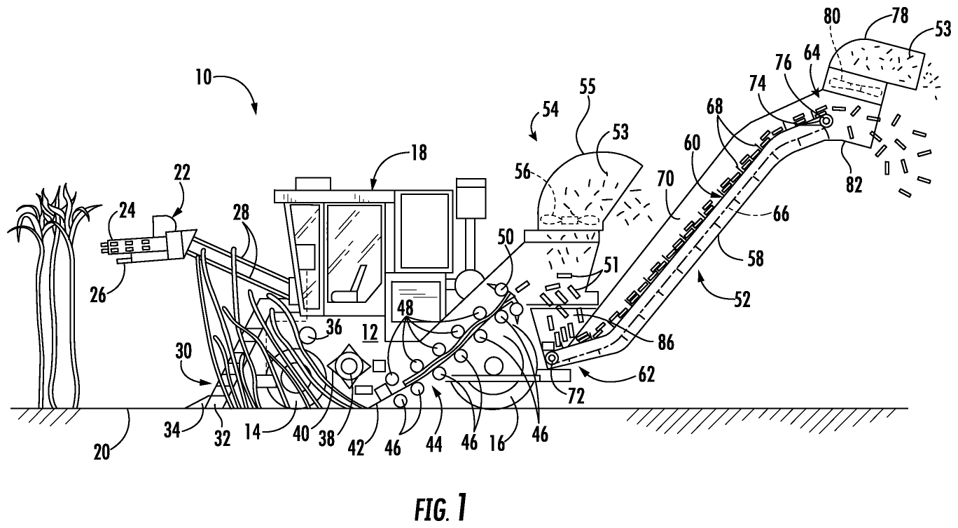

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator's cab 18. The harvester 10 may also include a primary source of power (e.g., an engine mounted on the frame 12) which powers one or both pairs of the wheels 14, 16 via a transmission (not shown). Alternatively, the harvester 10 may be a track-driven harvester and, thus, may include tracks driven by the engine as opposed to the illustrated wheels 14, 16. The engine may also drive a hydraulic fluid pump (not shown) configured to generate pressurized hydraulic fluid for powering various hydraulic components of the harvester 10.

The harvester 10 may include various components for cutting, processing, cleaning, and discharging sugarcane as the cane is harvested from an agricultural field 20. For instance, the harvester 10 may include a topper assembly 22 positioned at its front end to intercept sugarcane as the harvester 10 is moved in the forward direction. As shown, the topper assembly 22 may include both a gathering disk 24 and a cutting disk 26. The gathering disk 24 may be configured to gather the sugarcane stalks so that the cutting disk 26 may be used to cut off the top of each stalk. As is generally understood, the height of the topper assembly 22 may be adjustable via a pair of arms 28 hydraulically raised and lowered, as desired, by the operator.

The harvester 10 may further include a crop divider 30 that extends upwardly and rearwardly from the field 20. In general, the crop divider 30 may include two spiral feed rollers 32. Each feed roller 32 may include a ground shoe 34 at its lower end to assist the crop divider 30 in gathering the sugarcane stalks for harvesting. Moreover, as shown in FIG. 1, the harvester 10 may include a knock-down roller 36 positioned near the front wheels 14 and a fin roller 38 positioned behind the knock-down roller 36. As the knock-down roller 36 is rotated, the sugarcane stalks being harvested are knocked down while the crop divider 30 gathers the stalks from agricultural field 20. Further, as shown in FIG. 1, the fin roller 38 may include a plurality of intermittently mounted fins 40 that assist in forcing the sugarcane stalks downwardly. As the fin roller 38 is rotated during the harvest, the sugarcane stalks that have been knocked down by the knock-down roller 36 are separated and further knocked down by the fin roller 38 as the harvester 10 continues to be moved in the forward direction relative to the field 20.

Referring still to FIG. 1, the harvester 10 may also include a base cutter assembly 42 positioned behind the fin roller 38. As is generally understood, the base cutter assembly 42 may include blades (not shown) for severing the sugarcane stalks as the cane is being harvested. The blades, located on the periphery of the assembly 42, may be rotated by a hydraulic motor (not shown) powered by the vehicle's hydraulic system. Additionally, in several embodiments, the blades may be angled downwardly to sever the base of the sugarcane as the cane is knocked down by the fin roller 38.

Moreover, the harvester 10 may include a feed roller assembly 44 located downstream of the base cutter assembly 42 for moving the severed stalks of sugarcane from base cutter assembly 42 along the processing path. As shown in FIG. 1, the feed roller assembly 44 may include a plurality of bottom rollers 46 and a plurality of opposed, top pinch rollers 48. The various bottom and top rollers 46, 48 may be used to pinch the harvested sugarcane during transport. As the sugarcane is transported through the feed roller assembly 44, debris (e.g., rocks, dirt, and/or the like) may be allowed to fall through bottom rollers 46 onto the field 20.

In addition, the harvester 10 may include a chopper assembly 50 located at the downstream end of the feed roller assembly 44 (e.g., adjacent to the rearward-most bottom and top rollers 46, 48). In general, the chopper assembly 50 may be used to cut or chop the severed sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, pieces of debris 53 (e.g., dust, dirt, leaves, etc.) separated from the sugarcane billets 51 may be expelled from the harvester 10 through a primary extractor 54, which is located immediately behind the chopper assembly 50 and is oriented to direct the debris 53 outwardly from the harvester 10. Additionally, an extractor fan 56 may be mounted within the primary extractor 54 for generating a suction force or vacuum sufficient to pick up the debris 53 and force the debris 53 through the primary extractor 54. The separated or cleaned billets 51, heavier than the debris 53 being expelled through the extractor 54, may then fall downward to the elevator assembly 52.

As shown in FIG. 1, the elevator assembly 52 may include an elevator housing 58 and an elevator 60 extending within the elevator housing 58 between a lower, proximal end 62 and an upper, distal end 64. In general, the elevator 60 may include a looped chain 66 and a plurality of flights or paddles 68 attached to and evenly spaced on the chain 66. The paddles 68 may be configured to hold the sugarcane billets 51 on the elevator 60 as the billets are elevated along a top span of the elevator 70 defined between its proximal and distal ends 62, 64. Additionally, the elevator 60 may include lower and upper sprockets 72, 74 positioned at its proximal and distal ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Moreover, in some embodiments, pieces of debris 53 (e.g., dust, dirt, leaves, etc.) separated from the elevated sugarcane billets 51 may be expelled from the harvester 10 through a secondary extractor 78 coupled to the rear end of the elevator housing 58. For example, the debris 53 expelled by the secondary extractor 78 may be debris remaining after the billets 51 are cleaned and debris 53 expelled by the primary extractor 54. As shown in FIG. 1, the secondary extractor 78 may be located adjacent to the distal end 64 of the elevator 60 and may be oriented to direct the debris 53 outwardly from the harvester 10. Additionally, an extractor fan 80 may be mounted at the base of the secondary extractor 78 for generating a suction force or vacuum sufficient to pick up the debris 53 and force the debris 53 through the secondary extractor 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

During operation, the harvester 10 is traversed across the agricultural field 20 for harvesting sugarcane. After the height of the topper assembly 22 is adjusted via the arms 28, the gathering disk 24 on the topper assembly 22 may function to gather the sugarcane stalks as the harvester 10 proceeds across the field 20, while the cutter disk 26 severs the leafy tops of the sugarcane stalks for disposal along either side of harvester 10. As the stalks enter the crop divider 30, the ground shoes 34 may set the operating width to determine the quantity of sugarcane entering the throat of the harvester 10. The spiral feed rollers 32 then gather the stalks into the throat to allow the knock-down roller 36 to bend the stalks downwardly in conjunction with the action of the fin roller 38. Once the stalks are angled downwardly as shown in FIG. 1, the base cutter assembly 42 may then sever the base of the stalks from field 20. The severed stalks are then, by movement of the harvester 10, directed to the feed roller assembly 44.

The severed sugarcane stalks are conveyed rearwardly by the bottom and top rollers 46, 48, which compress the stalks, make them more uniform, and shake loose debris to pass through the bottom rollers 46 to the field 20. At the downstream end of the feed roller assembly 44, the chopper assembly 50 cuts or chops the compressed sugarcane stalks into pieces or billets 51 (e.g., 6 inch cane sections). The processed crop material discharged from the chopper assembly 50 is then directed as a stream of billets 51 and debris 53 into the primary extractor 54. The airborne debris 53 (e.g., dust, dirt, leaves, etc.) separated from the sugarcane billets is then extracted through the primary extractor 54 using suction created by the extractor fan 56. The separated/cleaned billets 51 then fall downwardly through an elevator hopper 86 into the elevator assembly 52 and travel upwardly via the elevator 60 from its proximal end 62 to its distal end 64. During normal operation, once the billets 51 reach the distal end 64 of the elevator 60, the billets 51 fall through the elevator discharge opening 82 to an external storage device. If provided, the secondary extractor 78 (with the aid of the extractor fan 80) blows out trash/debris 53 from harvester 10, similar to the primary extractor 54.

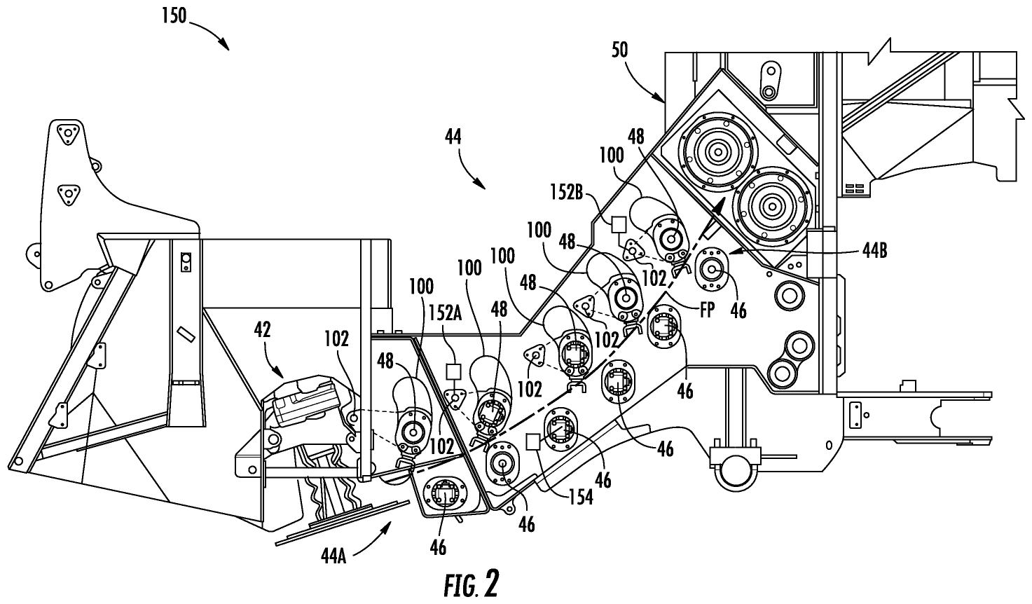

Referring now to FIG. 2, a side view of a portion of an agricultural harvester is illustrated in accordance with aspects of the present subject matter, particularly showing a side view of one embodiment of the feed roller assembly 44 of the agricultural harvester 10 described above with reference to FIG. 1. As shown in FIG. 2, the feed roller assembly 44 extends between a first end 44A and a second end 44B, with the first end 44A of the feed roller assembly 44 being adjacent the base cutter assembly 42 and the second end 44B of the feed roller assembly 44 being adjacent the chopper assembly 50. As such, the first end 44A of the feed roller assembly 44 is configured to receive severed sugarcane stalks from the base cutter assembly 42 and to convey the flow of severed sugarcane stalks along a flow path FP defined between the bottom and top rollers 46, 48 to the chopper assembly 50 at the second end 44B of the feed roller assembly 44. While the feed roller assembly 44 is shown as having six bottom rollers 46 and five top rollers 48, it should be appreciated that the feed roller assembly 44 may have any other suitable number of bottom and/or top rollers 46, 48.

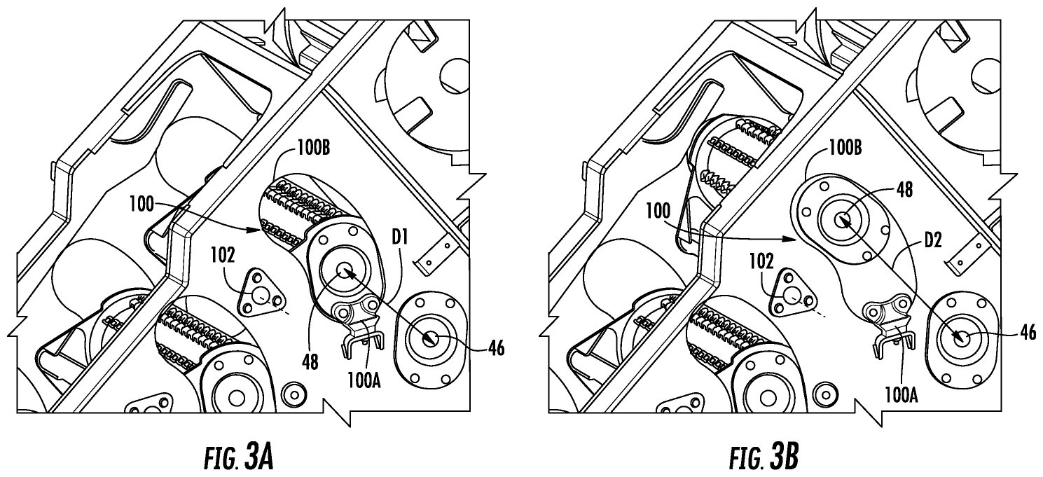

In general, as the sugarcane stalks are not perfectly uniform on the field, the flow of severed sugarcane stalks will inherently vary in thickness. As such, the top rollers 48 may be configured as floating rollers such that the spacing between the bottom and top rollers 46, 48 is variable to account for the change in the thickness of the flow of severed sugarcane stalks. For instance, in one embodiment, each of the top rollers 48 is movable within a respective slot 100. As particularly shown in FIGS. 3A and 3B, each slot 100 may extend between a first slot end 100A and a second slot end 100B. When the top roller 48 abuts against the first slot end 100A, the top roller 48 is in a lowest position, such that the top roller 48 is spaced by a first distance D1 from the respective bottom roller 46. When the top roller 48 abuts against the second slot end 100B, the top roller 48 is in a highest position, such that the top roller 48 is spaced by a second distance D2 from the respective bottom roller 46. In one embodiment, the first distance D1 is the closest that the top roller 48 may be from the bottom roller 46 and the second distance D2 is the furthest that the top roller 48 may be from the bottom roller 46. In some embodiments, the top rollers 48 are pivotable about a respective pivot joint 102 to move within the slot 100 between the first and second slot ends 100A, 100B. For instance, the top roller 48 may be pivoted about the pivot joint 102 between a first angular position, corresponding to the first distance D1, and a second angular position, corresponding to the second distance D2. However, in other embodiments, the top rollers 48 may be configured to move within the slot in any other suitable way.

Referring back to FIG. 2, during normal operation of the harvester as indicated above, foreign objects such as rocks or pieces of metal fed with the severed sugarcane stalks into the feed roller assembly 44 may shake out before reaching the chopper assembly 50. However, when such foreign objects do not shake out as expected before reaching the chopper assembly 50, for instance, if the foreign objects get trapped between sugarcane stalks or due to the foreign objects being too large, the blades of the chopper assembly 50 may be damaged when they hit the foreign objects, which reduces the efficiency of the harvester 10. Thus, in accordance with aspects of the present subject matter, a sensor assembly 150 is provided in association with the feed roller assembly 44 for detecting foreign objects within the flow of harvested materials through the feed roller assembly 44.

In one embodiment, the sensor assembly 150 may include a plurality of movement sensors 152 configured to generate data indicative of the displacement of the top rollers 48, such as an amount of the displacement, including the magnitude and/or rate of the displacement. For instance, the plurality of movement sensors 152 includes at least a first movement sensor 152A and a second movement sensor 152B. The first and second movement sensors 152A, 152B may be configured to generate displacement data indicative of the displacement of separate top rollers 48 of the feed roller assembly 44. For example, the first movement sensor 152A may generate displacement data indicative of displacement of one of the top rollers 48 and the second movement sensor 152B may generate displacement data indicative of displacement of another top roller 48 that is downstream of the top roller 48 associated with the first movement sensor 152A. It should be appreciated that while the sensor assembly 150 is shown as including only two movement sensors 152A, 152B, the sensor assembly 150 may include additional movement sensors 152, such as one or more additional movement sensors 152. It should further be appreciated that the movement sensors 152 may comprise any suitable sensors or combination of sensors for generating displacement data indicative of the displacement of the top rollers 48, such as angular position sensors, accelerometers, and/or the like. Additionally, it should be appreciated that it may be advantageous to monitor displacement of top rollers 48 that are not directly adjacent the chopper 50 such that there is more time to detect and react to foreign objects present within the flow of harvested materials through the feed roller assembly 44.

During normal operation of the harvester 10, the thickness of the flow of severed sugarcane stalks may vary somewhat such that the top rollers 48 experience an expected pattern of displacement. However, when a foreign object, such as a large stone or piece of metal, is present within the flow of severed sugarcane stalks, the top rollers 48 will experience a larger displacement and/or a faster displacement than usual. As such, as will be described in greater detail below, a controller of the disclosed system may be configured to monitor the displacement data received from the movement sensors 152 to determine when a foreign object is present within the flow of severed sugarcane stalks. For instance, the controller may be configured to monitor the sensor data for displacements that are larger and/or faster than usual at the top rollers 48 associated with the first and second movement sensors 152A, 152B to determine that a foreign object is present within the flow of harvested materials. For example, the controller may be configured to monitor the sensor data relative to one or more displacement thresholds, such as at least one displacement threshold and/or at least one displacement rate threshold. For instance, the magnitudes of displacement of the top rollers 48 may be compared to the displacement threshold(s) and/or the rates of displacement of the top rollers 48 may be compared to the displacement rate threshold(s). When a larger displacement than a displacement threshold and/or a faster displacement than a displacement rate threshold is determined at one roller based on the data from the first movement sensor 152A and another displacement that is larger than a displacement threshold and/or faster than a displacement rate threshold is determined at a downstream roller based on the data from the second movement sensor 152B (e.g., at a subsequent time corresponding to a time delay determined based on the distance between the two rollers and the speed at which the flow of severed sugarcane stalks is being directed through the feed roller assembly 44), the controller may determine that a foreign object is present within the flow of severed sugarcane stalks.

Similarly, the controller may be configured to monitor the sensor data for displacement profiles of the top rollers 48 associated with the first and second movement sensors 152A, 152B that are different than usual to determine that a foreign object is present within the flow of harvested materials. For example, the controller may be configured to monitor the sensor data relative to one or more average displacement profiles. For instance, the height, width, sharpness/flatness, etc. of profile portions of the displacement profiles associated with the top rollers 48 may be compared to average displacement profiles(s). When a profile portion that is different than an average displacement profile is determined at one roller based on the data from the first movement sensor 152A and another profile portion that is different than an average displacement profile is determined at a downstream roller based on the data from the second movement sensor 152B (e.g., at a subsequent time corresponding to a time delay determined based on the distance between the two rollers and the speed at which the flow of severed sugarcane stalks is being directed through the feed roller assembly 44), the controller may determine that a foreign object is present within the flow of severed sugarcane stalks.

Further, in some embodiments, the sensor assembly 150 may also include one or more metal detecting sensors 154 configured to generate data indicative of a metallic property of the flow of severed sugarcane stalks. For instance, each of the metal detecting sensors 154 may be associated with (e.g., positioned within) a respective one of the bottom rollers 46. The bottom rollers 46 associated with the metal detecting sensor(s) 154 may be made of a non-metallic material so that the material of the bottom rollers 46 does not interfere with the sensing of the metal detecting sensor(s) 154. It should be appreciated that the metal detecting sensor(s) 154 may be any suitable sensors for generating data indicative of a metallic property, such as the magnetic field, of the flow of severed sugarcane stalks. It should additionally be appreciated that the metal detecting sensor(s) 154 may additionally or alternatively be associated with one or more of the top rollers 48.

During normal operation of the harvester 10, the flow of severed sugarcane stalks should have little to no metallic property (e.g., magnetic field). However, when a foreign object, such as a piece of metal, is present within the flow of severed sugarcane stalks, the sensed metallic properties of the flow of severed sugarcane stalks increases. As such, as will be described in greater detail below, a controller of the disclosed system may be configured to monitor the data received from the metal detecting sensor(s) 154 to determine when a metallic foreign object is present within the flow of severed sugarcane stalks. For instance, the controller may be configured to determine that a metallic foreign object is present in the feed roller assembly when a metallic property of the flow of severed sugarcane stalks determined based on data from the metal detecting sensor(s) is greater than a metallic property threshold.

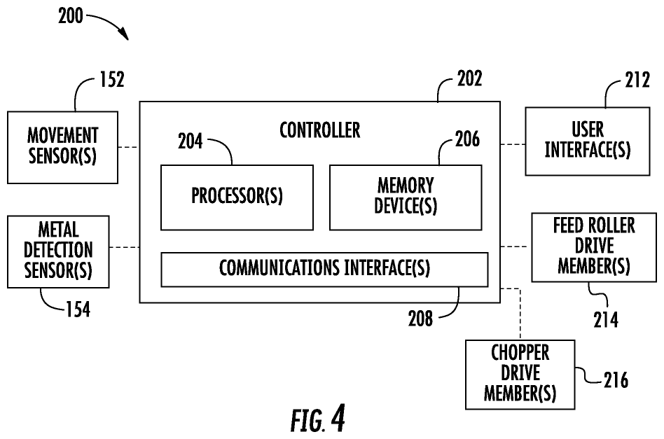

Referring now to FIG. 4, a schematic view of one embodiment of a system 200 for detecting foreign objects within a feed roller assembly of an agricultural harvester is illustrated in accordance with aspects of the present subject matter. In general, the system 200 will be described with reference to the agricultural harvester 10 described with reference to FIG. 1 and the feed roller assembly 44 described with reference to FIGS. 2-3B. However, it should be appreciated that the disclosed method 300 may be implemented with harvesters having any other suitable configurations and/or with feed roller assemblies having any other suitable configuration.

As shown in FIG. 4, the system 200 may include a controller 202 and various other components configured to be communicatively coupled to and/or controlled by the controller 202. For instance, the controller 202 may be communicatively coupled to the movement sensor(s) 152 (e.g., first and second movement sensors 152A, 152B) that generate displacement data indicative of the displacement of two or more top rollers 48 of the feed roller assembly 44. Further, the controller 202 may be communicatively coupled to the metal detection sensor(s) 154 configured to generate data indicative of a metallic property of the flow of severed sugarcane stalks through the feed roller assembly 44. Further, the controller 202 may be communicatively coupled to and/or configured to control a user interface 212. The user interface 212 described herein may include, without limitation, any combination of input and/or output devices that allow an operator to provide inputs to the controller 202 and/or that allow the controller 202 to provide feedback to the operator, such as a keyboard, keypad, pointing device, buttons, knobs, touch sensitive screen, mobile device, audio input device, audio output device, and/or the like. Moreover, the controller 202 may be communicatively coupled to and/or configured to control one or more feed roller drive members 214, such as a motor (e.g., hydraulic motor) coupled to the feed roller assembly 44. Additionally, the controller may be communicatively coupled to and/or configured to control one or more chopper drive members 216, such as a motor (e.g., hydraulic motor) coupled to the chopper assembly 50.

In general, the controller 202 may comprise any suitable processor-based device known in the art, such as a computing device or any suitable combination of computing devices. Thus, in several embodiments, the controller 202 may include one or more processor(s) 204, and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 206 of the controller 202 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 206 may generally be configured to store suitable computer-readable instructions that, when implemented by the processor(s) 204, configure the controller 202 to perform various computer-implemented functions, such as one or more aspects of the methods and algorithms that will be described herein. In addition, the controller 202 may also include various other suitable components, such as a communications circuit or module, one or more input/output channels, a data/control bus and/or the like.

It should be appreciated that, in several embodiments, the controller 202 may correspond to an existing controller of the agricultural harvester 10. However, it should be appreciated that, in other embodiments, the controller 202 may instead correspond to a separate processing device. For instance, in one embodiment, the controller 202 may form all or part of a separate plug-in module that may be installed within the agricultural harvester 10 to allow for the disclosed system and method to be implemented without requiring additional software to be uploaded onto existing control devices of the agricultural harvester 10.

In some embodiments, the controller 202 may be configured to include one or more communications modules or interfaces 208 for the controller 202 to communicate with any of the various system components described herein. For instance, one or more communicative links or interfaces (e.g., one or more data buses) may be provided between the communications interface 208 and the sensor(s) 152, 154 to receive displacement data indicative of the displacement of the top rollers 48 and data indicative of a metallic property of the flow of severed sugarcane stalks within the feed roller assembly 44. Further, one or more communicative links or interfaces (e.g., one or more data buses) may be provided between the communications interface 208 and a user interface (e.g., user interface 212) to allow operator inputs to be received by the controller 202 and/or the allow the controller 202 to control the operation of one or more components of the user interface 212. Moreover, one or more communicative links or interfaces (e.g., one or more data buses) may be provided between the communications interface 208 and the feed roller drive member(s) 214 to allow the controller 202 to control the operation of the feed roller drive member(s) 214. Additionally, one or more communicative links or interfaces (e.g., one or more data buses) may be provided between the communications interface 208 and the chopper drive member(s) 216 to allow the controller 202 to control the operation of the chopper drive member(s) 216.

As indicated above, the controller 202 may be configured to detect foreign objects within a feed roller assembly of an agricultural harvester (e.g., feed roller assembly 44 of agricultural harvester 10) based at least in part on displacement data indicative of the displacement of two or more top rollers (e.g., top rollers 48) of the feed roller assembly and/or data indicative of a metallic property of flow of harvested materials through the feed roller assembly. For example, the controller 202 may include one or more suitable relationships and/or algorithms stored within its memory 206 that, when executed by the processor 204, allow the controller 202 to detect or determine the presence of a foreign object within the feed roller assembly 44 based on the data from the movement sensors 152 and/or the metal detecting sensor(s) 154.

For instance, the controller 202 may be configured to monitor displacement data from the movement sensors 152 indicative of an amount (e.g., magnitude and/or rate) of displacement of at least two of the top rollers 48 of the feed roller assembly 44. The controller 202 may identify instances where the displacement conditions at the top rollers 48 differ from expected displacement condition standards and coincide with one another. For example, the controller 202 may identify instances where the displacement amounts of the monitored top rollers 48 exceed an associated threshold and/or if portions of a displacement profile associated with the top rollers 48 differ from expected displacement profiles, and further determine if an instance of displacement exceeding the threshold and/or differing from an expected displacement profile at a first monitored top roller 48 matches an instance at a downstream one of the monitored top rollers 48. For example, based on a known distance along the flow path FP between one of the monitored top rollers 48 and a subsequent, downstream monitored top roller 48 (e.g., where the distance may be predetermined and stored within the memory 206) and a speed of the harvested materials being fed through the feed roller assembly 44, the controller 202 may determine an expected time delay for an object traveling from the one of the monitored top rollers 48 to the subsequent, downstream monitored top roller 48. If an instance of displacement that exceeds the associated threshold and/or differs in profile from an expected profile occurs at one of the monitored top rollers 48 and, following the time delay, an instance of displacement that exceeds the associated threshold and/or differs in profile from an expected profile occurs at the subsequent top roller 48, the controller 202 may determine that a foreign object is present.

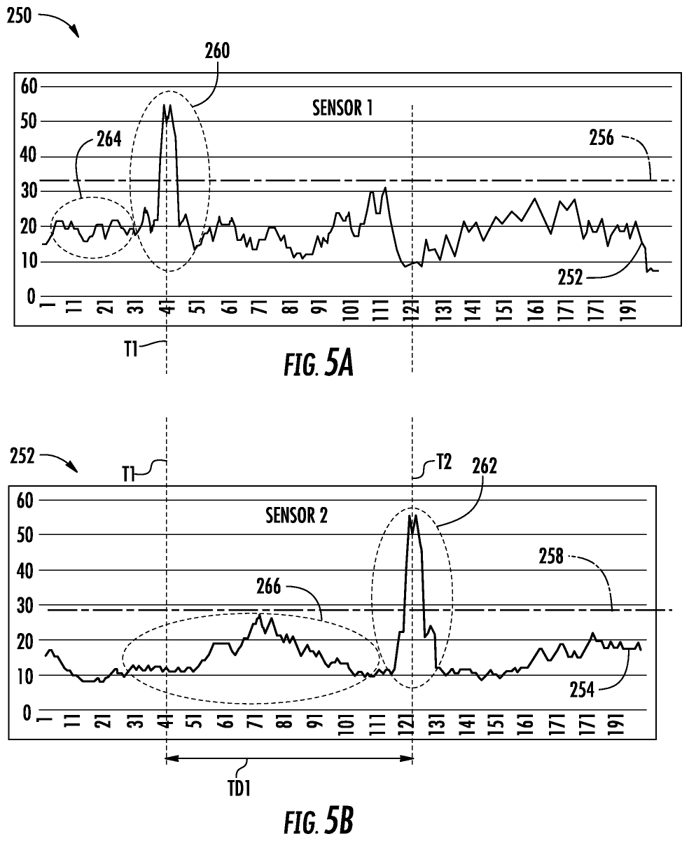

For instance, referring to FIGS. 5A and 5B, example embodiments of displacement maps generated from data collected by movement sensors of a sensor assembly for detecting foreign objects within a feed roller assembly of an agricultural harvester are illustrated in accordance with aspects of the present subject matter. Particularly, FIG. 5A illustrates a displacement map 250 of a first roller of the plurality of top rollers 48 and FIG. 5B illustrates a displacement map 252 of a second downstream roller of the plurality of top rollers 48. For example, displacement data from the first displacement sensor 152A may be used by the controller 202 to generate the first displacement map 250 for indicating the displacement of a first one of the top rollers 48 of the feed roller assembly 44 and displacement data from the second displacement sensor 152B may be used by the controller 202 to generate the second displacement map 250 for indicating the displacement of a second, downstream one of the top rollers 48 of the feed roller assembly 44. It should be appreciated that, in embodiments with more than two monitored top rollers 48, an additional displacement map may be generated for the displacement of each further monitored top roller 48.

As shown in FIGS. 5A and 5B, a first displacement profile 252 associated with the first top roller 48 is generated based on the displacement data for the first top roller 48 and a second displacement profile 254 associated with the second top roller 48 is generated based on the displacement data for the second top roller 48. The first and second displacement profiles 252, 254 may indirectly or directly indicate the position and/or rate of displacement of the top rollers 48 at each given time. For instance, the displacement data from the movement sensors 152A, 152B may include raw signal data that is mapped to indirectly indicate the position and/or rate of displacement of the top rollers 48 at each given time. Alternatively, the raw signal data from the movement sensors 152A, 152B may be transformed (e.g., using one or more predefined relationships between the raw data and the corresponding position and/or rate) and then mapped to directly indicate the position and/or rate of displacement of the top rollers 48 at each given time.

Due to the profile of the flow of sugarcane stalks becoming more uniform in profile as the flow of sugarcane stalks reaches closer to the second end 44B (FIG. 2) of the feed roller assembly 44, the first displacement profile 252 of the first top roller 48 has a different expected profile when compared to the second displacement profile 254 of the second top roller 48. For instance, as shown in FIGS. 5A and 5B, the first displacement profile 252 of the first top roller 48 has a less smooth pattern overall when compared to an overall pattern of the displacement profile 254 of the second top roller 48. Similarly, the amount that the first roller 48 is displaced is generally greater in magnitude and/or rate than at the second roller 48. As such, a first threshold 256 for the amount of displacement required to infer that a foreign object just passed by the first monitored roller may be higher than a second threshold 258 required to infer that such foreign object just passed by the second, downstream monitored roller. However, in some embodiments, the thresholds 256, 258 may be the same for the displacement of both of the first and second top rollers 48. It should be appreciated that the thresholds 256, 258 may be determined in any suitable manner. The controller 202 may monitor displacement conditions (e.g., amounts, profile portions, etc.) of the displacement profiles 252, 254 relative to displacement condition standards (e.g., threshold amounts, expected profiles, etc.) to determine that a foreign object is present within the feed roller assembly 44.

For instance, the controller 202 may monitor the displacement profiles 252, 254 to determine when an amount of displacement of the first and/or second top rollers 48 is above the associated threshold(s) 256, 258. For example, a first instance 260 of the displacement of the first top roller 48 exceeding the first threshold 256 is detected at a first time T1. Similarly, a second instance 262 of the displacement of the second top roller 48 exceeding the second threshold 258 is detected at a second time T2. Based on a known distance between the monitored first and second top rollers 48 and a current speed of the harvested materials being fed through the feed roller assembly 44, a time delay TD1 is determined. If displacements that exceed the threshold(s) 256, 258 at the first and second top rollers 48 are spaced apart by or within a certain range of the time delay TD1 (e.g., within +/−10% of the time delay TD1, within +/−5% of the time delay TD1, and/or the like), the controller 202 determines that a foreign object is present within the feed roller assembly 44. For example, in the illustrated embodiment, since the times T1, T2 of the first and second instances 260, 262 are spaced apart by the time delay TD1, the controller 202 may be configured to determine that a foreign object is present within the feed roller assembly 44.

Similarly, the controller 202 may additionally, or alternatively, monitor each of the displacement profiles 252, 254 relative to local average or expected profiles of portions of the displacement profiles. The local average profiles may be generated based on an average of previous data points. For example, the local average profiles may be generated based at least in part on an average of a predetermined number of previous profile portions or data points, such as the last five, ten, fifteen, etc. data points, or all of the previous data points. However, the local average profile may be determined and/or provided in any other suitable way. Instances of abnormal movement are noted by the controller if a local profile portion of the displacement profile varies significantly from the local average profile (e.g., height, width, sharpness, etc.). If a local profile portion (e.g., first instance 260) is determined in the first displacement profile 252 to be too different from the local average profile (e.g., first local average profile 264), and a local profile portion (e.g., second instance 262) is determined in the second displacement profile 254 to be too different from the respective local average profile (e.g., second local average profile 266), where the profiles of the instances are similar to each other (e.g., in shape) and/or occur at times spaced apart by the time delay TD1, then the controller 202 may determine that a foreign object is present within the feed roller assembly 44.

Referring back to FIG. 4, the controller 202 may similarly be configured to monitor data from the metal detecting sensor(s) 154 indicative of a metallic property of the flow of harvested materials directed through the feed roller assembly 44. The controller 202 may determine that a metallic foreign object is present if the monitored metallic property of the flow of harvested material exceeds a metallic property threshold. For instance, the metallic property of the flow of harvested materials may include a magnetic field of the flow of harvested materials. Sugarcane stalks and other field materials alone generate little to no magnetic field when interacting with the metal detecting sensor(s) 154. Thus, if a magnetic field is detected within the flow of harvested materials based on the data received from the metal detecting sensor(s) 154, the controller 202 determines that a metallic object is present within the flow of harvested materials.

Once the controller 202 determines that a foreign object is present within the flow of sugarcane stalks based on the displacement data from the movement sensors 152 and/or the data from the metal detecting sensor(s) 154, the controller 202 may be configured to perform a control action to prevent damage of the chopper assembly 50 downstream of the feed roller assembly 44. For instance, when the controller 202 determines that a foreign object is present within the feed roller assembly 44, the controller 202 may automatically control the operation of the user interface 212 to provide an operator notification associated with the foreign object, notifying an operator of the agricultural harvester 10 of the foreign object so that the operator may take actions to protect the chopper assembly 50 from damage. In some embodiments, the controller 202 is additionally or alternatively configured to automatically control an operation of the feed roller drive member(s) 214 to slow down or stop the feed roller assembly 44 to protect the chopper assembly 50 from damage. Similarly, in some embodiments, the controller 202 is additionally or alternatively configured to automatically control an operation of the chopper drive member(s) 216 to slow down or stop the chopper assembly 50 to protect the chopper assembly 50 from damage.

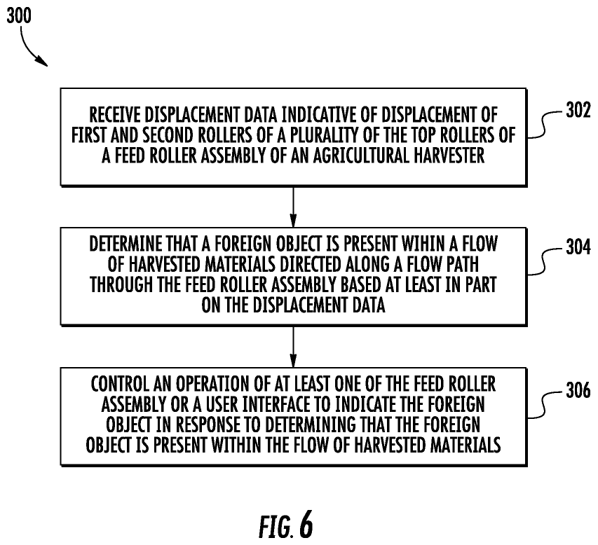

Referring now to FIG. 6, a flow diagram of one embodiment of a method 300 for detecting foreign objects within a feed roller assembly of an agricultural harvester is illustrated in accordance with aspects of the present subject matter. In general, the method 300 will be described herein with reference to the agricultural harvester 10 described with reference to FIG. 1, the feed roller assembly 44 described with reference to FIGS. 2-3B, and the various components of the system 200 described with reference to FIG. 4. However, it should be appreciated that the disclosed method 300 may be implemented with harvesters having any other suitable configurations, with feed roller assemblies having any other suitable configuration, and/or within systems having any other suitable system configuration. In addition, although FIG. 6 depicts steps performed in a particular order for purposes of illustration and discussion, the methods discussed herein are not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 6, at (302), the method 300 may include receiving displacement data indicative of displacement of first and second rollers of a plurality of top rollers of a feed roller assembly of an agricultural harvester. For instance, as described above, the controller 202 may receive displacement data from the first movement sensor 152A that is indicative of displacement of a first roller of the plurality of top rollers 48 of the feed roller assembly 44 and displacement data from the second movement sensor 152B displacement of a second roller of the plurality of top rollers 48. The displacement data may be indicative of an amount of each of the displacements of the first and second top rollers 48, such as a magnitude and/or a rate of each of the displacements of the first and second top rollers 48.

Further, at (304), the method 300 may include determining that a foreign object is present within a flow of harvested materials directed along a flow path through the feed roller assembly based at least in part on the displacement data. For example, as discussed above, the controller 202 may determine that a foreign object is present within the flow of sugarcane stalks directed through feed roller assembly 44 along the flow path FP when a displacement of the first top roller 48 and a displacement of the second top roller 48 that both exceed the associated threshold(s) and/or differ from expected profiles are spaced apart by a time period equal to, or approximately equal to, the time delay TD1.

Additionally, at (306), the method 300 may include controlling an operation of at least one of the feed roller assembly or a user interface to indicate the foreign object in response to determining that the foreign object is present within the flow of harvested materials. For instance, as discussed above, the controller 202 may control an operation of the user interface 212 to indicate to an operator of the agricultural harvester 10 that a foreign object is present within the feed roller assembly 44, control an operation of the drive member(s) 214 of the feed roller assembly 44 to slow down or stop the feed roller assembly 44, and/or control an operation of the chopper drive member(s) 216 of the chopper assembly 50 to slow down or stop the chopper assembly 50 in response to determining that a foreign object is present within the feed roller assembly 44 to protect the chopper assembly 50 from damage.

It is to be understood that the steps of the method 300 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for detecting foreign objects within an agricultural harvester, the system comprising:
a feed roller assembly extending between a first end and a second end and including a plurality of bottom rollers and a plurality of top rollers, the feed roller assembly being configured to receive a flow of harvested materials and direct the flow of harvested materials along a flow path defined between the plurality of bottom rollers and the plurality of top rollers from the first end of the feed roller assembly to the second end of the feed roller assembly;
a first movement sensor configured to generate displacement data indicative of displacement of a first roller of the plurality of top rollers;
a second movement sensor configured to generate displacement data indicative of displacement of a second roller of the plurality of top rollers; and
a controller communicatively coupled to the first and second movement sensors, the controller being configured to determine when a foreign object is present within the flow of harvested materials based at least in part on the displacement data received from the first and second movement sensors.

2. The system of claim 1, wherein the controller is configured to monitor the displacement data relative to at least one displacement condition standard, the controller being configured to determine that the foreign object is present within the flow of harvested materials when the displacement data indicates that displacement of each of the first and second rollers differs from the at least one displacement condition standard.

3. The system of claim 2, wherein the at least one displacement condition standard comprises at least one displacement threshold,
wherein the second roller is spaced apart downstream of the first roller along the flow path, the controller being configured to determine that the foreign object is present within the flow of harvested materials when the displacement data indicates that the first roller is displaced by a first amount exceeding the at least one displacement threshold and that the second roller is subsequently displaced following a time delay by a second amount exceeding the at least one displacement threshold.

4. The system of claim 3, wherein the controller is configured to determine the time delay based at least in part on a known distance between the first and second rollers and a speed at which the flow of harvested materials is being directed through the feed roller assembly.

5. The system of claim 3, wherein the first and second amounts comprise first and second displacement rates and the at least one displacement threshold comprises a displacement rate threshold.

6. The system of claim 2, wherein the at least one displacement condition standard comprises at least one expected profile,
wherein the second roller is spaced apart downstream of the first roller along the flow path, the controller being configured to determine that the foreign object is present within the flow of harvested materials when a first profile portion of a data profile of the displacement data associated with the first roller differs from the at least one expected profile and that a second profile portion of a data profile of the displacement data associated with the second roller differs from the at least one expected profile,
wherein the second profile portion occurs subsequent to the first profile portion following a time delay.

7. The system of claim 1, wherein the controller is further configured to perform a control action when it is determined that the foreign object is present within the flow of harvested materials, the control action comprising controlling an operation of at least one of a feed roller drive member to stop the feed roller assembly, a chopper drive member to stop a chopper assembly directly downstream of the feed roller assembly, or a user interface to provide an operator notification associated with the foreign object.

8. The system of claim 1, further comprising a metal detecting sensor associated with at least one of the plurality of bottom rollers or the plurality of top rollers, the metal detecting sensor being configured to generate data indicative of a metallic property of the flow of harvested materials,
wherein the controller is communicatively coupled to the metal detecting sensor, the controller being configured to determine that a metallic object is present in the flow of harvested materials based at least in part on the metallic property of the flow of harvested material exceeding a metallic property threshold.

9. The system of claim 1, wherein the agricultural harvester comprises a sugarcane harvester.

10. A sugarcane harvester, comprising:
a base cutter assembly configured to sever sugarcane stalks;
a feed roller assembly extending between a first end and a second end and including a plurality of bottom rollers and a plurality of top rollers, the feed roller assembly being configured to receive a flow of the sugarcane stalks from the base cutter assembly and direct the flow of the sugarcane stalks along a flow path defined between the plurality of bottom rollers and the plurality of top rollers from the first end of the feed roller assembly to the second end of the feed roller assembly;
a chopper assembly configured to receive the flow of the sugarcane stalks from the feed roller assembly and chop the flow of the sugarcane stalks into billets;
a first movement sensor configured to generate displacement data indicative of displacement of a first roller of the plurality of top rollers;
a second movement sensor configured to generate displacement data indicative of displacement of a second roller of the plurality of top rollers; and
a controller communicatively coupled to the first and second movement sensors, the controller being configured to determine when a foreign object is present within the flow of the sugarcane stalks based at least in part on the displacement data received from the first and second movement sensors and to control an operation of the agricultural harvester when the foreign object is present in the flow of the sugarcane stalks to protect the chopper assembly.

11. The sugarcane harvester of claim 10, wherein the controller is configured to monitor the displacement data relative to at least one displacement condition standard, the controller being configured to determine that the foreign object is present within the flow of the sugarcane stalks when the displacement data indicates that displacement of each of the first and second rollers differs from the at least one displacement condition standard.

12. The sugarcane harvester of claim 11, wherein the at least one displacement condition standard comprises at least one displacement threshold,
wherein the second roller is spaced apart downstream of the first roller along the flow path, the controller being configured to determine that the foreign object is present within the flow of the sugarcane stalks when the displacement data indicates that the first roller is displaced by a first amount exceeding the at least one displacement threshold and that the second roller is subsequently displaced following a time delay by a second amount exceeding the at least one displacement threshold.

13. The sugarcane harvester of claim 11, wherein the at least one displacement condition standard comprises at least one expected profile,
wherein the second roller is spaced apart downstream of the first roller along the flow path, the controller being configured to determine that the foreign object is present within the flow of the sugarcane stalks when a first profile portion of a data profile of the displacement data associated with the first roller differs from the at least one expected profile and that a second profile portion of a data profile of the displacement data associated with the second roller differs from the at least one expected profile,
wherein the second profile portion occurs subsequent to the first profile portion following a time delay.

14. The sugarcane harvester of claim 10, further comprising a metal detecting sensor associated with at least one of the plurality of bottom rollers or the plurality of top rollers, the metal detecting sensor being configured to generate data indicative of a metallic property of the flow of harvested materials,
wherein the controller is communicatively coupled to the metal detecting sensor, the controller being configured to determine that a metallic object is present in the flow of harvested materials based at least in part on the metallic property of the flow of material exceeding a metallic property threshold.

15. A method for detecting foreign objects for an agricultural harvester, the agricultural harvester having a feed roller assembly extending between a first end and a second end, the feed roller assembly including a plurality of bottom rollers and a plurality of top rollers, the feed roller assembly being configured to receive a flow of harvested materials and direct the flow of harvested materials along a flow path defined between the plurality of bottom rollers and the plurality of top rollers from the first end of the feed roller assembly to the second end of the feed roller assembly, the method comprising:
receiving, with one or more computing devices, displacement data indicative of displacement of a first roller of the plurality of top rollers and displacement of a second roller of the plurality of top rollers;
determining, with the one or more computing devices, that a foreign object is present within the flow of harvested materials based at least in part on the displacement data; and
controlling, with the one or more computing devices, an operation of one or more components of the agricultural harvester in response to determining that the foreign object is present within the flow of harvested materials.

16. The method of claim 15, further comprising monitoring the displacement data relative to at least one displacement condition standard,
wherein determining that the foreign object is present within the flow of harvested materials comprises determining that displacement of each of the first and second rollers differs from the at least one displacement condition standard.

17. The method of claim 16, wherein the at least one displacement condition standard comprises at least one displacement threshold,
wherein the second roller is spaced apart downstream of the first roller along the flow path,
wherein determining that the foreign object is present within the flow of harvested materials comprises determining that the first roller is displaced by a first amount exceeding the at least one displacement threshold and that the second roller is subsequently displaced following a time delay by a second amount exceeding the at least one displacement threshold.

18. The method of claim 17, further comprising determining the time delay based at least in part on a distance between the first and second rollers and a speed at which the flow of harvested materials is directed through the feed roller assembly.

19. The method of claim 15, further comprising:
receiving, with the one or more computing devices, data indicative of a metallic property of the flow of harvested materials; and
determining, with the one or more computing devices, that a metallic object is present in the flow of harvested materials based at least in part on the metallic property of the flow of material exceeding a metallic property threshold.

20. The method of claim 15, wherein controlling the operation of the one or more components of the agricultural harvester comprises controlling an operation of at least one of a feed roller drive member to stop the feed roller assembly, a chopper drive member to stop a chopper assembly directly downstream of the feed roller assembly, or a user interface to provide an operator notification associated with the foreign object.
